(19) United States
(12) Patent Application Publication
(10) Pub. No.: US 2023/0251444 A1
(43) Pub. Date: Aug. 10, 2023

(54) AERIAL DROP OPTICAL FIBRE CABLE

(71) Applicant: Sterlite Technologies Limited, Haryana (IN)

(72) Inventors: Vikash Shukla, Haryana (IN); Kawarpreet Singh, Haryaba (IN)

(21) Appl. No.: 18/165,998

(22) Filed: Feb. 8, 2023

(30) Foreign Application Priority Data
Feb. 9, 2022 (IN) 202211006992

(51) Int. Cl. G02B 6/44; H01B 7/18

(52) U.S. Cl. CPC G02B 6/4416; G02B 6/4403; G02B 6/4494; H01B 7/18

(57) ABSTRACT

The present invention relates to an optical fibre cable (100, 200) with a sheath (106) surrounding one or more tubes (104) and one or more strength members (108) partially embedded in the sheath (106). Each of the one or more tubes (104) encloses at least one optical fiber (102) having a diameter of 200±20 um. In particular, one or more tubes (104) has a tube length greater than a cable length. Moreover, the one or more tubes (104) has a young's modulus of less than or equal to 700 N and a lay-length of equal to or more than 400 mm. Further, the optical fiber cable (100, 200) breaks at a pre-defined load.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### CROSS REFERENCE TO RELATED APPLICATION

This application claims the benefit of Indian Application No. 202211006992 titled “AERIAL DROP OPTICAL FIBRE CABLE” filed by the applicant on Feb. 9, 2022, which is incorporated herein by reference in its entirety.

### FIELD

The present invention relates to the field of optical fibers for optical fiber transmission systems and more particularly, relate to an aerial drop optical fibre cable.

### BACKGROUND OF THE INVENTION

With the advent of new technologies and lower prices, the introduction of fiber optic installation in residential homes or “Fiber-To-The-Home” (FTTH) is coming closer to reality. In a passive optical network, small optical cables containing only a few fibers will be deployed directly onto customer premises for providing video, data and voice connections with superior quality and bandwidth. The optical cables need to be designed with appropriate materials so that long term fiber and cable reliability are obtained at a cost that is acceptable for the distribution market.

Conventional copper cables have limited data transmission bandwidth and are subject to electromagnetic interference. Conventional optical fiber cables are designed for different applications and thus, do not have the features which are required for FTTH applications such as compatibility with existing hardware, self-support over large distances, and low flammability.

To overcome the limitations of the copper cables, the laying of overhead cables has increased rapidly due to the advancement in optical networks. The overhead cables are laid to reduce load on pipeline resources and reduce cost of laying cables. The overhead cables include optical fiber cables used for aerial applications, thus known as aerial drop optical fiber cables. The aerial drop optical fiber cables are typically used for fiber to the home application. The aerial drop optical fiber cables are compact in structure and has a layer stranded structure.

The aerial drop optical fiber cables include multiple number of tubes with each tube having multiple number of optical fibers. In addition, the aerial drop optical fiber cables need to have a pre-defined break load in order to be installed aerially complying with the safety standards. So, a proper choice of cable components is very crucial for developing these cables. The tubes used in the conventional cables are made of materials such as Polypropylene and Polybutylene Terephthalate. However, these cables with tubes made of such materials may not meet the required breakload requirements.

Conventional aerial drop cables may be reinforced by metallic materials such as steel or copper, or non-conductive materials such as carbon fibers, aramid fibers, or glass reinforced epoxy rods. For example, U.S. Pat. No. 4,199,225 discloses an optical cable which utilizes a pair of steel or carbon fiber reinforcing wires disposed on opposite sides of a bore housing optical fibers in order to provide longitudinal support and protection against a crushing force applied to the optical cable. U.S. Pat. No. 4,199,225 discloses an optical cable which utilizes a pair of reinforcing members such as steel wire or carbon fiber disposed on opposite sides of a bore housing optical fibers in order to provide longitudinal support and protection against a crushing force applied to the optical cable.

CN113419319A discloses an aerial drop optical fiber cable having an optical fiber ribbon array surrounded by a water blocking layer and an outer jacket. Another prior art JP2004117867A discloses an optical fiber cable with optical fiber positioned inside a storage section and strength members embedded in the sheath. Yet another prior art CN111580233A discloses an optical fiber cable comprising a cable core and an outer sheath and is characterized in that the cable core is formed by twisting optical fiber bundles. However, CN113419319A and JP2004117867A discloses drop cables and the lay-length of fiber ribbons inside the core but not about the lay length of the tubes. However, CN111580233A does not talk about the lay length of the fibers and the tubes.

In light of the above-stated discussion, there is an urgent need for a technical solution that overcomes the above-stated limitations in the conventional optical fibre cable. The present invention focuses on an optical fibre cable for aerial application with optimized construction parameters and pre-defined break load.

### SUMMARY OF THE INVENTION

Embodiments of the present invention provide an optical fiber cable comprising one or more tubes enclosing at least one optical fiber. In particular, the one or more tubes have a tube length greater than a cable length, a young's modulus of less than or equal to 700 N, and a lay-length of equal to or more than 400 mm. A sheath surrounding the one or more tubes and one or more strength members (at least partially embedded in the sheath.

In accordance with an embodiment of the present invention, the one or more tubes (104) have an extra tube length (ETL) between 0.02% to 0.2%, wherein the extra tube length (ETL)=*100.

In accordance with an embodiment of the present invention, at least one optical fiber is a ribbon such that adjacent optical fibers in the ribbon are intermittently connected along length.

In accordance with an embodiment of the present invention, the plurality of air knives is arranged such that the fluid enters or exits the optical fiber draw tower at an angle of 0-89 degrees with respect to the vertical path.

In accordance with an embodiment of the present invention, the tube length is 0 to 2% longer than the cable length.

The optical fiber has a macrobend loss of less than or equal to 0.75 dB/turn at 1550 nm when at least one optical fiber is bent around a mandrel of 10 mm radius. The optical fiber (102) has a diameter of 200±20 um.

In accordance with another embodiment of the present invention, the optical fiber comprising a water blocking gel in one or more tubes.

According to an aspect of the present invention, the optical fiber (has a fiber length 2% greater than the cable length.

Another aspect of the invention relates to an optical fiber cable comprising one or more tubes enclosing at least one optical fiber with a diameter of 200±20 um, a sheath surrounding the one or more tubes and one or more strength members embedded in the sheath. The optical fiber has a macrobend loss of less than or equal to 0.75 dB/turn at 1550 nm when the at least one optical fiber is bent around a mandrel of 10 mm radius, and the optical fiber cable breaks at a pre-defined load.

In accordance with an embodiment of the present invention, the number optical fibers in the optical fiber cable is greater than or equal to 72.

In accordance with an embodiment of the present invention, each of the one or more strength members is stranded metallic wires.

In accordance with an embodiment of the present invention, the one or more tubes have a young's modulus of less than or equal to 700N and a lay-length of equal to or more than 400 mm.

The foregoing solutions of the present invention are attained by providing a multi-core optical fiber.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 is a pictorial snapshot illustrating an optical fibre cable for aerial applications in accordance with one embodiment of the present invention; and

FIG. 2 is a pictorial snapshot illustrating an optical fibre cable for aerial applications in accordance with another embodiment of the present invention.

### REFERENCE LIST

Optical fiber cable 100/200
One or more tubes 104
Optical fiber 102
Sheath 106
One or more strength members 108

The optical fiber cable is illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE PREFERRED EMBODIMENTS

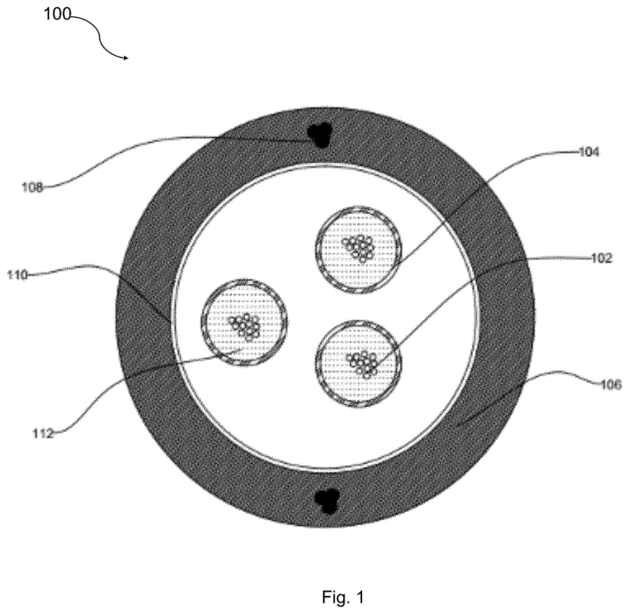

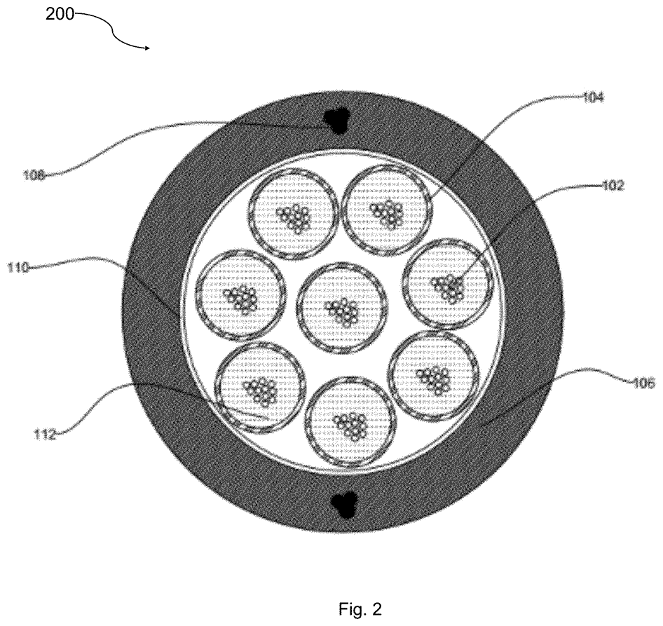

The principles of the present invention and their advantages are best understood by referring to FIG. 1 to FIG. 2. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present invention:

Optical fiber refers to a medium associated with transmission of information over long distances in the form of light pulses. The optical fiber uses light to transmit voice and data communications over long distances when encapsulated in a jacket/sheat.

ITU.T, stands for International Telecommunication Union-Telecommunication Standardization Sector, is one of the three sectors of the ITU. The ITU is the United Nations specialized agency in the field of telecommunications and is responsible for studying technical, operating and tariff questions and issuing recommendations on them with a view to standardizing telecommunications on a worldwide basis.

Lay length is a longitudinal distance along the length of the optical fiber cable required for the one or more tubes to go all the way around each other.

Young's modulus (E) is a property of the material that tells how easily it can stretch and deform. The young's modulus (E) is defined as a ratio of tensile stress (σ) to tensile strain (ε), where stress is the amount of force applied per unit area (σ=F/A) and strain is extension per unit length (ε=dl/l).

Medium density polyethylene is a thermoplastic material produced by chromium/silica catalysts, Ziegler-Natta catalysts or metallocene catalyst.

FIG. 1 and FIG. 2 are pictorial snapshots illustrating optical fibre (100/200) cables for aerial applications in accordance with one or more embodiments of the present invention. The optical fiber cable 100 is used for telecommunication applications and networking applications and can be installed aerially for fiber to the home applications (FTTH). In particular, the optical fiber cable 100 adopts a layer stranded optical cable structure which includes optical fibers enclosed inside loose tubes and a water absorbing or blocking compound filled inside the loose tubes.

The optical fiber cable 100 is a work safe optical fiber cable with a predefined breaking load. In particular, the predefined breaking load is necessary in order for the optical fiber cable 100 to be installed aerially and comply with safety standards. Further, the optical fiber cable 100 includes elements which have properties different from elements made of conventional materials. The properties of the elements of the optical fiber cable 100 are changed in order for the optical fiber cable 100 to be installed aerially and possess the pre-defined breaking load.

The optical fiber cable 100 has a reduced diameter suitable for aerial drop applications. In addition, the optical fiber cable 100 has low optical attenuation. Further, the optical fiber cable 100 has low Young's modulus of tubes which enables easy installation. The optical fibre cable 100 includes one or more tubes 104, a sheath 106 and one or more strength members 108. Each of the one or more tubes 104 encloses at least one optical fiber 102. In an aspect of the present invention, the optical fiber cable 100 includes a first layer 110. In general, an optical fiber cable includes a plurality of fibers and carries information in the form of data between two places using light technology. The optical fiber cable 100 is a cable used for carrying light over long distances. Furthermore, the optical fiber cable 100 may simply be used to transmit optical signals (which may carry sensor data or communication data).

In accordance with an embodiment of the present invention, at least one optical fiber 102 extends longitudinally along a length of the optical fiber cable 100. In an aspect, the optical fiber cable 100 includes a plurality of optical fibers. The at least one optical fiber 102 is a fiber used for transmitting information as light pulses from one end to another. In particular, at least one optical fiber 102 is a thin strand of glass or plastic capable of transmitting optical signals. Moreover, at least one optical fiber 102 is configured to transmit large amounts of information over long distances with relatively low attenuation.

In accordance with an embodiment of the present invention, the optical fiber 102 includes a core region and a cladding region. The core region is an inner part of an optical fiber and the cladding section is an outer part of the optical fiber. In particular, the core region is defined by a central longitudinal axis of each of the at least one optical fiber 102 and the cladding region surrounds the core region. Moreover, the core region and the cladding region are formed along the central longitudinal axis of at least one optical fiber 102. Further, the core region and the cladding region are formed during the manufacturing stage of at least one optical fiber 102. The core region has a refractive index which is greater than a refractive index of the cladding region.

In an aspect of the present invention, the one optical fiber 102 has a diameter of 200±20 um. Alternatively, the diameter of the optical fiber 102 may vary.

In an aspect of the present invention, the one optical fiber 102 is a single mode fiber. Alternatively, optical fiber 102 is a multimode fiber.

In an aspect of the present invention, the at least one optical fiber 102 is at least one of loose fibers, flat ribbon, corrugated ribbon and Intermittently Bonded Ribbon. Alternatively, the at least one optical fiber 102 is a ribbon such that adjacent optical fibers in the ribbon are intermittently connected along length.

In accordance with an embodiment of the present invention, the optical fiber 102 is characterized by a macrobend loss. In particular, optical fibers experience additional propagation losses due to bending by coupling light from core modes (guided modes) to cladding modes when they are bent. Moreover, the macrobend loss occurs when the fibers in a cable are bent and subjected to a significant amount of bending above a critical value of curvature. Further, the at least one optical fiber 102 used in the one or more tubes 104 are insensitive to macrobend losses in order to obtain the optical fiber cable 100 with low optical attenuations.

In accordance with an embodiment of the present invention, the optical fiber 102 has the macrobend loss of less than or equal to 0.75 dB/turn at 1550 nm when the optical fiber 102 is bent around a mandrel of 10 mm radius.

The optical fiber cable 100 includes one or more tubes 104. Each of the one or more tubes 104 encloses at least one optical fiber 102. In an exemplary example, each of the one or more tubes 104 encloses 12 optical fibers. Alternatively, one or more tubes 104 may enclose any number of optical fibers.

In an aspect of the present invention, the number of at least one optical fiber 102 in the optical fiber cable 100 is greater than equal to 72. Alternatively, the number of optical fiber 102 in the optical fiber cable 100 may vary.

In another aspect of the present invention, each of the one or more tubes 104 surrounds at least one optical fiber 102. In particular, the one or more tubes 104 covers optical fiber 102. Moreover, the one or more tubes 104 include one of loose tubes, buffer tubes, tight buffered tubes and the like. Further, each of the one or more tubes 104 is a tube for encapsulating the optical fiber 102 and provides support and protection to the optical fiber 102 against crush, bend and stretch. Furthermore, the one or more tubes 104 protect the optical fiber 102 and prevent ingression of water inside. Additionally, the one or more tubes 104 provide mechanical isolation, physical damage protection and identification of each of the at least one optical fiber 102. Alternatively, the one or more tubes 104 provide a single layer core construction.

The optical fiber cable 100 includes three tubes (as shown in FIG. 1) in accordance with one embodiment of the present invention. Alternatively in different embodiments, the optical fiber cable 100 includes eight tubes (as shown in FIG. 2). In particular, the one or more tubes 104 are stranded around each other. In an aspect, the stranding is S-Z stranding. Moreover, the one or more tubes 104 wound around each other in sections with a first direction of winding in an S-shape alternating with the sections with a second direction of winding in a Z-shape. Further, the first direction is a clockwise direction and the second direction is an anticlockwise direction. And, the SZ stranding of the one or more tubes 104 is performed in order to maintain a uniform lay length, mid-spanning and achieve higher production speeds as compared to helical stranding.

Additionally, the S-Z stranding allows uniform distribution of the stress across the one or more tubes 104. And, the S-Z stranding may have any number of turns between the S-shape and the Z-shape.

In accordance with an embodiment of the present invention, the one or more tubes 104 are characterized by a tube length and the optical fiber cable 100 is characterized by a cable length. At least one optical fiber 102 has a fiber length. In an aspect, the fiber length is 0 to 2% greater than the cable length.

The tube length of the one or more tubes 104 is greater than the cable length of the optical fiber cable 100. In one aspect, the tube length is 0 to 2% greater than the cable length. Alternatively, tube length may be different. The one or more tubes 104 are characterized by a young's modulus of less than or equal to 700 N. Alternatively, young's modulus may be different.

Further, the one or more tubes 104 are characterized by a lay length of equal to or more than 400 mm and low young's modulus. Alternatively, the one or more tubes 104 are stranded with high lay length because the one or more tubes 104 is made of a material with low young's modulus. The one or more tubes 104 may get physically damaged if the lay length is kept low.

The one or more tubes 104 may be characterized by an extra tube length (ETL). The extra tube length and extra fiber length is very low in the optical fiber cable 100 because of the high lay-length. In an aspect, the one or more tubes 104 have the extra tube length (ETL) between 0.02% to 0.2%. The extra tube length (ETL)=*100.

The optical fiber cable 100 may not meet break load requirements if the young's modulus of the one or more tubes 104 is greater than 700 N. If the lay length of the one or more tubes 104 is less than 400 mm, then the one or more tubes 104 having the low young's modulus may face physical damage and in turn may affect optical fibers. This may induce optical losses in the optical fibers. If the extra tube length (ETL) is below 0.02%, the optical fibers may experience mechanical stresses and may get damaged during handling of the optical fiber cable 100. If the extra tube length (ETL) is above 0.2%, the lay length of the one or more tubes 104 has to be kept low which is not desired for the one or more tubes 104 with low young's modulus.

In accordance with an embodiment of the present invention, the one or more tubes 104 are made of easy peelable material. Alternatively, the one or more tubes 104 may be made of any other suitable material. The cross section of one or more tubes 104 is circular in shape. Alternatively, the cross section of the one or more tubes 104 may be of any suitable shape.

In an aspect of the present invention, the one or more tubes 104 have a uniform structure and dimensions. The one or more tubes 104 have a different thickness. Alternatively, the thickness of one or more tubes 104 is equal. In an aspect of the present invention, the thickness of one or more tubes 104 is in a range of about 0.1-0.25 millimeter. Alternatively, the thickness of the one or more tubes 104 may vary.

Furthermore, the one or more tubes 104 have an inner diameter and an outer diameter. In one aspect of the present invention, the inner diameter and the outer diameter of the one or more tubes 104 is fixed. The inner diameter of the one or more tubes 104 is in a range of about 0.9-1.35 millimeter. Alternatively, the inner diameter of the one or more tubes 104 may vary.

In an aspect of the present invention, the outer diameter of each of the one or more tubes 104 is in a range of about 1.1-1.5 millimeter. Alternatively, the outer diameter of the one or more tubes 104 may vary

The optical fiber cable 100 includes the sheath 106 encapsulating one or more tubes 104. In an aspect, the sheath 106 encapsulates one or more layers surrounding the one or more tubes 104 (explained below).

In an aspect of the present invention, the sheath 106 is made of one of UV (Ultra Violet radiations) proof black medium density polyethylene material and UV proof black high density polyethylene material. Alternatively, the sheath 106 may be made of any other suitable material. In particular, the sheath 106 protects the optical fiber cable 100 from harsh environment and harmful UV rays. In addition, the sheath 106 has the inherent ability to resist crushes, kinks and tensile stress.

In an aspect of the present invention, the sheath 106 has a thickness in a range of about 1.2-1.8 millimeter. Alternatively, the sheath 106 may have any suitable thickness.

The optical fiber cable 100 includes one or more strength members 108 partially embedded in the sheath 106. In an aspect, the one or more strength members 108 is embedded substantially parallel to a longitudinal axis of the optical fiber cable 100. Alternatively, the one or more strength members 108 may not lie parallel to the longitudinal axis. In particular, the one or more strength members 108 provide tensile strength and stiffness to the optical fiber cable 100. Further, each of the one or more strength members 108 is stranded metallic wires. In an aspect, the stranded metallic wires are made of steel. In an aspect, the metallic wires are made of brass plated steel wires. Further, the one or more strength members 108 are characterized by a diameter. The one or more strength members 108 have a diameter in a range of about 0.3-0.8 mm. Alternatively, the diameter of the one or more strength members 108 may vary. The number of metallic wires in the one or more strength members 108 are 3. Alternatively, the number of metallic wires in the one or more strength members 108 may be more or less than 3. The number of the one or more strength members 108 is two and placed diagonally opposite. Alternatively, the number of the one or more strength members 108 may vary.

In accordance with an embodiment of the present invention, the optical fiber cable 100 includes one or more layers. The one or more layers include the first layer 110. The first layer 110 is made of binder yarns for binding a core of the optical fiber cable 100. In particular, the binder yarn is an aramid yarn or any suitable binder yarn. Further, one or more layers may include more layers such as but not limited to a water blocking tape layer, a water swellable yarn layer, fire retardant tape layer, binder tape layer and the like.

In an aspect, the optical fiber cable 100 includes a water blocking gel 112 filled inside the one or more tubes 104. In particular, the water blocking gel 112 is a thixotropic gel to prevent ingression of water inside each of the one or more tubes 104 and provide a cushioning to the optical fibers. The one or more tubes 104 may be loose tubes, buffer tubes and tight buffered tubes.

In accordance with an aspect of present invention, the optical fiber cable 100 may or may not include a ripcord. The ripcord is disposed inside the sheath 106 and lies substantially along the longitudinal axis of the optical fiber cable 100. In particular, the ripcord enables tearing of the sheath 106 to facilitate access to the one or more tubes 104. Further, the ripcord may be made of a polyester material or any other suitable material. The ripcord has a circular cross-section.

The optical fiber cable 100 may have a suitable diameter in a range of about 5-8 millimeters.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention. It is intended that the specification and examples be considered as exemplary, with the true scope of the invention being indicated by the claims.

We claim:

1. An optical fiber cable (100, 200) comprising:
one or more tubes (104) enclosing at least one optical fiber (102), wherein the one or more tubes (104) have a tube length greater than a cable length, a young's modulus of less than or equal to 700 N, and a lay-length of equal to or more than 400 mm;
a sheath (106) surrounding the one or more tubes (104); and
one or more strength members (108) at least partially embedded in the sheath (106).

2. The optical fiber cable (100, 200) as claimed in claim 1, wherein the one or more tubes (104) have an extra tube length (ETL) between 0.02% to 0.2%.

3. The optical fiber cable (100, 200) as claimed in claim 1, wherein the extra tube length (ETL)=*100.

4. The optical fiber cable (100, 200) as claimed in claim 1, wherein the at least one optical fiber (102) is a ribbon.

5. The optical fiber cable (100, 200) as claimed in claim 1, wherein adjacent optical fibers in the ribbon are intermittently connected along length.

6. The optical fiber cable (100, 200) as claimed in claim 1, wherein the tube length is 0 to 2% longer than the cable length.

7. The optical fiber cable (100, 200) as claimed in claim 1, wherein the at least one optical fiber (102) has a macrobend loss of less than or equal to 0.75 dB/turn at 1550 nm when the at least one optical fiber (102) is bent around a mandrel of 10 mm radius.

8. The optical fiber cable (100, 200) as claimed in claim 1, wherein the at least one optical fiber (102) has a diameter of 200±20 um.

9. The optical fiber cable (100, 200) as claimed in claim 1, further comprising a water blocking gel (112) in the one or more tubes (104).

10. The optical fiber cable (100, 200) as claimed in claim 1, wherein the at least one optical fiber (102) has a fiber length.

11. The optical fiber cable (100, 200) as claimed in claim 1, wherein the fiber length is 0 to 2% greater than the cable length.

12. An optical fiber cable (100, 200) comprising:
one or more tubes (104), wherein each of the one or more tubes (104) encloses at least one optical fiber (102), wherein the at least one optical fiber (102) has a diameter of 200±20 um;
a sheath (106) surrounding the one or more tubes (104); and
one or more strength members (108) embedded in the sheath (106), wherein the at least one optical fiber (102) has a macrobend loss of less than or equal to 0.75 dB/turn at 1550 nm when the at least one optical fiber (102) is bent around a mandrel of 10 mm radius, wherein the optical fiber cable (100, 200) breaks at a pre-defined load.

13. The optical fiber cable (100, 200) as claimed in claim 12, wherein a number of at least one optical fiber (102) in the optical fiber cable (100, 200) is greater than or equal to 72.

14. The optical fiber cable (100, 200) as claimed in claim 12, wherein each of the one or more strength members (106) is stranded metallic wires.

15. The optical fiber cable (100, 200) as claimed in claim 12, wherein the one or more tubes (104) have a young's modulus of less than or equal to 700N.

16. The optical fiber cable (100, 200) as claimed in claim 12, wherein the one or more tubes (104) have a lay-length of equal to or more than 400 mm.

17. The optical fiber cable (100, 200) as claimed in claim 12, wherein the at least one optical fiber (102) has a fiber length, wherein the fiber length is 0 to 2% greater than a cable length of the optical fiber cable (100, 200).

18. The optical fiber cable (100, 200) as claimed in claim 12, wherein the at least one optical fiber (102) is a ribbon such that adjacent optical fibers in the ribbon are intermittently connected along length.

19. The optical fiber cable (100, 200) as claimed in claim 12, wherein the at least one optical fiber (102) has a macrobend loss of less than or equal to 0.75 dB/turn at 1550 nm when the at least one optical fiber (102) is bent around a mandrel of 10 mm radius.

20. The optical fiber cable (100, 200) as claimed in claim 12, wherein the one or more tubes (104) have an extra tube length (ETL) between 0.02% to 0.2%, and the extra tube length (ETL)=*100.
